(19) United States
(12) Patent Application Publication
(10) Pub. No.: US 2004/0255036 A1
(43) Pub. Date: Dec. 16, 2004

(54) System and method for providing computer services

(76) Inventor: James D. Yee, (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/627,337

(22) Filed: Jul. 25, 2003

Related U.S. Application Data
(60) Provisional application No. 60/398,127, filed on Jul. 25, 2002.

(51) Int. Cl. G06F 15/16; G06F 12/14; H04L 9/32

(52) U.S. Cl. 709/229; 713/200

(57) ABSTRACT

A system for providing computing functions to a user, the system comprising: an access controller, a trans-media controller, and at least one computing output device, the access controller being configured to be controlled by the user so as to permit the user to selectively establish an access communication connection with the trans-media controller, and to communicate with the trans-media controller through the access communication connection, the trans-media controller being configured to perform at least one computing function in response to a communication from the access controller via the acc ss communication connection, generate an output of said computing function, selectively establish a distribution communication connection with a target computing output device; and to transmit the output to the target computing output device; and each of the computing output devices being configured to form a distribution communication connection with the trans-media controller, receive the output from the trans-media controller via the distribution communication connection; and to actualize the output for the user.

### CROSS-REFERENCE TO RELATED APPLICATIONS

This application claims the benefit of U.S. application Ser. No. 60/398,127, filed Jul. 25, 2002, the contents of which are incorporated herein by reference.

### FIELD OF THE INVENTION

This invention relates to the general field of computing, and more particularly, to personal computing.

### BACKGROUND OF THE INVENTION

The use of computers by the general public for both personal and business purposes has grown substantially since the personal computer was first introduced. It is common for computer users to have a computer at home for personal use, and to own or have access to another computer at work for use in connection with employment or business. However, there is also a need by many users to access computerfiles and applications, for viewing or printing, or to obtain Internet access, at other locations besides the traditional home or office.

One common response is to use portable notebook or laptop computers. Since these are full computers, they generally provide access to all of the user's data and applications. However, this solution is unsatisfactory for a number of reasons. While portable, these computers are generally still too heavy and cumbersome to be conveniently transported by a mobile user. Further, they have poor battery life, are costly, and usually need to find an Internet connection in order to access the Internet.

Personal Digital Assistants have more recently appeared which are light enough to be universally transportable. However, these devices are too small to hold anything more than a small sample of the user's files, and also usually require a communication outlet to be found in order to access the Internet.

Another approach is to make use of computer terminals provided for public use, such as at airports or Internet cafes. While these units readily provide Internet access, they conversely do not generally provide access to user's familiar files and applications.

Another practice is for the user to carry personal files and applications on a floppy disc or similar storage medium. The information can be retrieved and used by inserting the disc in a functioning computer. The problems with this approach however are that floppy discs are very limited in capacity, while the larger discs usually conform to a proprietary standard and therefore will not have widely available disc readers. Further, even if the data can be transferred, the remote computer may not have the user's application, and may otherwise be difficult for the user to use.

Yet another approach that has been suggested involves integrating computer intelligence and Bluetooth type communications into all types of devices, including everyday appliances. While this could make Internet access more conveniently available, it would not improve access to a user's personal files and applications. Further, the solution would be rather costly.

In the absence of an effective portable solution, computer users will continue to be inconvenienced when seeking access to their files and applications, peripherals such as printers, and the Internet, while they are travelling or otherwise away from their home or office.

### SUMMARY OF THE INVENTION

What is desired is a system and method which overcomes one or more of the problems associated with the current devices and methods used for providing remote access to computer services.

Most particularly, the system and method should enable widespread access to the computer services. This is achieved in the present system by enabling the use of computer output devices that would otherwise be unavailable, through use of a simple hardware device to provide the computer output devices with communication receiving capability. Additionally, there is incentive for commercial providers to supply computer output devices to service users. The system should enable users to access the system without requiring bulky, heavy, or inconvenient equipment. Preferably, an ubiquitous, inexpensive device like a telephone or cell phone would be used. Preferably the system and method would provide access to the users personal data and applications, the Internet, and other applications. It is also preferable for the computer services to be identifiable for security purposes, so that theft of information could be prevented. Finally, it would be preferable for the system be low cost, and not require the creation or expense of acquiring a substantial amount of new equipment.

Accordingly, there is provided a system for providing computing functions to a user, said system comprising;

(a) an access controller, a trans-media controller, and at least one computing output device;

(b) the access controller being configured to:

(1) be controlled by said user so as to permit the user to selectively establish an access communication connection with the trans-media controller; and to

(2) communicate with said trans-media controller through said access communication connection;

(c) the trans-media controller being configured to:

(1) perform at least one computing function in response to a communication from the access controller via the access communication connection;

(2) generate an output of said computing function;

(3) selectively establish a distribution communication connection with a target computing output device; and to

(4) transmit said output to the target computing output device; and

(d) each of the computing output devices being configured to:

(1) form a distribution communication connection with the trans-media controller;

(2) receive the output from the trans-media controller via the distribution communication connection; and to

(3) actualize the output for the user.

### BRIEF DESCRIPTION OF THE DRAWINGS

Reference will now be made, by way of example only, to preferred embodiments of the invention as illustrated in the attached figures.

FIG. 1 is a symbolic representation of the System and Method for Providing Computer Services of the present invention;

FIG. 2 is a symbolic representation of the network connector of the present invention;

FIG. 3 illustrates the steps executed by the system during a session to facilitate access to data and/or applications; and

FIG. 4 illustrates the steps taken by the trans-media controller to facilitate communication from an access controller to one or more computing output devices, in response to a session request signal.

### DETAILED DESCRIPTION OF THE PREFERRED EMBODIMENTS

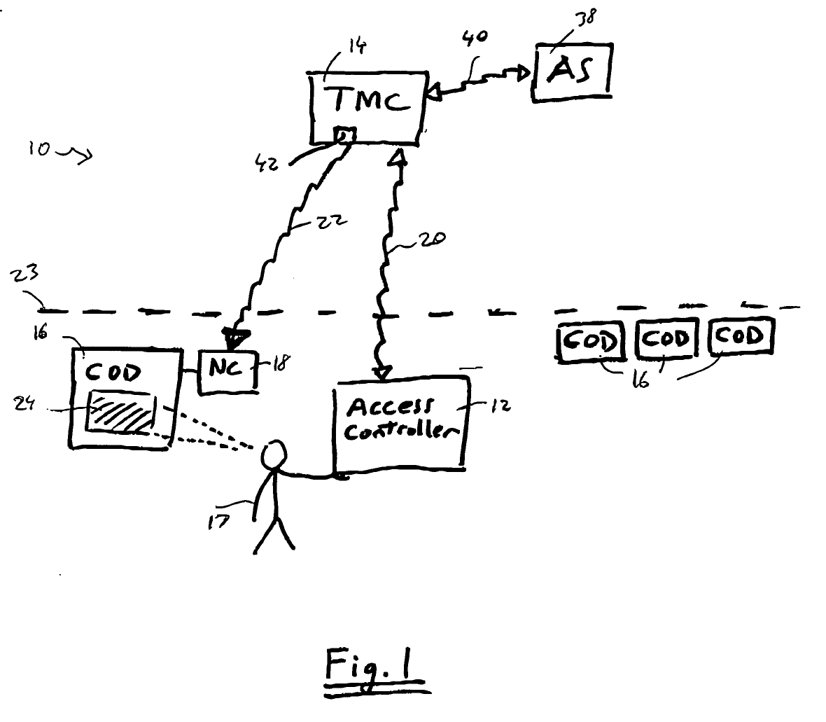

The system for providing computer services of the present invention is shown in FIG. 1. The system as a whole is generally indicated by reference numeral 10, and broadly comprises an access controller 12 (for convenience, also referred to as “AC”), a trans-media controller 14 (“TMC”), and at least one computing output device 16 (“COD”). A representation of a user 17 is shown in the figure.

A network connector 18 (“NC”) is shown attached to the COD 16. Communication may be established between the access controller 12 and the trans-media controller 14 through an access communication connection (“ACC”) 20, which is shown as a jagged line in the figure. Similarly, a distribution communication connection (“DCC”) 22 may be formed between the trans-media controller 14 and the computing output device 16. The network connector 18 is shown attached or operatively connected to the computing output device 16, so that a signal received by the network connector is passed on, upon being processed by the NC, to the COD.

For added context, a dotted line 23 is shown dividing a bottom portion of the figure from the top. The portion below the dotted line 23 represents that part of the system that is directly viewed by or interacted with by the user 18. Conversely, the portion above the dotted line represents system components that are managed by system providers and would not typically be viewed by a user.

The system of the present invention generally provides computing functions to the user 18 through a display or other output on the computing output device 16. As discussed in greater detail below, the COD's may generally be located in a wide variety of public and private locations remote from the user's home or place of work. In this way, computing functions or services may be provided to a user where they would otherwise be unavailable.

The computing output device 16 is any device or object that provides a computer output function. Such functions generally present a computer-generated result in a form that can be accessed or conveniently used by a user, such as an display image, print-out, sound or audio-clip, or file storage. Accordingly, the computing output device 16 will most commonly be a display monitor, printer, audio-speakers, or file storage device, though other devices or objects are also possible. In the context of the present invention the computing output device 16 will preferably be a video display monitor. When other devices such as printers are used, they will preferably be accompanied by a video display monitor as well, but the presence of a display monitor is not required. For illustration purpos s, in FIG. 1 the user 17 is shown viewing a screen 24 of a COD 16 display monitor.

Each computing output device 16 in the system of the present invention includes a unique identifier that acts to distinguish a particular COD from all of the others in the system. The unique identifier may be represented in any manner convenient to fulfill its purpose, and preferably comprises a sequential combination of letters and numbers, but may also comprise a sequence of numbers, letters, or other symbols, alone or in some combination.

The computing output devices 16 are further configured to transmit their unique indentifier to the user 17. This could be in as simple a form as a visual transmission, through display of the identifier on the computing output device, for example, on a label attached to the outside surface. Preferably, the unique identifier is transmitted electronically, and may be in the form of an international standard such as the Bluetooth communication protocol.

Each of the computing output devices 16 in the present system has an associated network connector 18. The function of the NC 18 is to provide communication capability to the COD 16, which is generally a “dumb” device that does not, on its own, have any means to communicate with other devices. Specifically, the network connector 18 provides the circuitry to form the distribution communication connection 22 with the trans-media controller 14, and also provides the means by which the unique identifier may be transmitted electronically to the user.

The network connector 18 may be removably attached to a COD, usually to an external connector, or built into the COD. In FIG. 1, the COD 16 display monitor being viewed by the user 17 has an external NC 18. On the right side of the figure are shown a bank of three COD's 16. These might comprise, for example, a display monitor, printer, and file storage device, or alternatively three display monitors, set up in a retail establishment such as a coffee shop for the convenience of customers. In that situation, it is preferable to build the NC integral with the COD, and accordingly the NC 18 is not shown in the figure. In the case of the COD 16 being viewed by the user, it can be appreciated that the network connector 18 will be sized and shaped to be operatively connected by the user to the computing output device 16. In particular, the NC 18 will likely have an external connector or plug adapted to connect with the video-in input port on the outside of the display monitor COD 16. Similarly, for the COD's on the right, it can be appreciated that the network connector 18 will be sized and shaped to be installed as an integral component in the computing output devices 16.

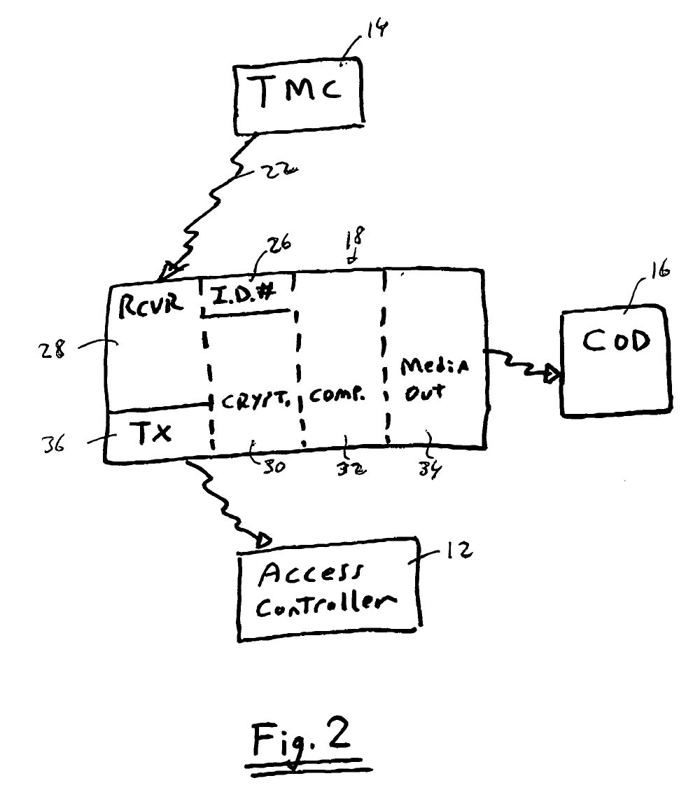

A detailed diagram of the network connector 18 is shown in FIG. 2. It can be seen that the unique identifier, indicated by reference number 26, is actually contained or embedded in the network controller 18 associated with each computing output device 16. There is shown a communication receiver or circuit 28, which is adapted to receive a communication signal, and a cryptograph circuit 30, operatively connected to the communication receiver 28, to unscramble the communication signal. The network connector 18 also includes a decompression circuit 32, operatively connected to the cryptograph circuit 30, which functions to to decompress a communication signal, and a media output circuit 34, which is operatively connected to the decompression circuit 32, which provides and adapts the communication signal for output to the computing output device 16. The cryptograph circuit 30 and decompression circuit 32 are not always required in the network connector 18, and may be included as needed. Finally, there is also shown a communication transmitter 36 which may be used to transmit the unique identifier 26 to the user or a proximate communication device (preferably in the form of the access controller, described below).

As noted, the transmitter 36 may transmit in accordance with an international communication standard such as Bluetooth. Similarly, the communication receiver 28 may be configured to receive communication signals according to an international communication standard such as Wi-Fi. In FIG. 2, the distribution communication connection 22 may compris a Wi-Fi connection, or it may be Wi-Fi only from the network connector 18 to a local high speed Internet connection, which carries the signal to the TMC. This latter configuration would be preferable in an environment such as a cafe or other retail establishment, which takes advantage of Wi-Fi to provide wireless connectivity to its patrons.

In general, the network connector 18 carried and installed by a user will be shaped and be sufficiently small in size to be conveniently portable. It can also be appreciated that network connectors 18 are customized according to the type of COD being used, particularly with respect to the media output circuit 34. For example, for a COD display monitor, the media output circuit 34 will provide an output suitable for connection to a video in port on a display monitor. For a printer COD, the output will be configured for a parallel printer port or USB connection.

The access controller 12 is any device that the user uses to inform the system or TMC 14 that it wishes to receive a computing function on a particular COD 16, and that may be used to further instruct the TMC 14. The access controller 12 may access the access communication connection 20 through a wireless or wired connection. Preferably, the access controller 12 is a portable or cellular telephone, since such devices are truly portable and convenient, and are increasingly common among the general public. Other devices that could be used as an access controller 12 include any type of wireless telephone, pagers, and personal data assistants or mobile computers with communication capability, and land based telephones.

The access controller 12 is configured to be controlled by the user so as to permit the user to selectively establish an access communication connection with the trans-media controller. By “selectively establish” it is meant that the user chooses or selects when he wishes to obtain a computing function on a particular or target COD, and then initiates the transaction by sending an appropriate signal to the TMC.

As noted, the unique identifier must first be entered into the access controller. The access controller will preferably be configured to receive a manual input of the identifier. Therefore, where the identifier is obtained manually such as from a label on the COD, the user will manually input the number into the access controller. On a cellular phone, this will consist of entering the identifier using the device keyboard. Where the identifier is transmitted electronically, such as by Bluetooth, the access controller will preferably be configured to receive the electronic form of the identifier. Further, the access controller will be configured to transmit the unique identifier to the trans-media controller through the access communication connection 20.

Upon communication being established with the TMC, the access controller may be used to provide further instructions with respect to the desired computing output function. Accordingly, the access controller is preferably configured to provide to the trans-media controller instructions relating to the position of a pointer or cursor. The access controller will include at least one input feature, such as buttons of a keyboard or a joystick, and the access controller will be configured so that activating the input feature directs the trans-media controller to change the position of a pointer or cursor in a predetermined direction and by a predetermined distance. For example, there may be four buttons which when pressed move the cursor up, down, left, and right, respectively. Alternatively movement of a joystick may move the cursor in a corresponding fashion. It can be appreciated that the preferred access controller of the present invention in effect acquires the functionality of a computer mouse. The input features of the access controller are also configured to provide keyboard input. Generally, there will be a designated key on the access controller that will toggle the access controller between keyboard and mouse modes. Another input feature could be speaking into the phone, where the spoken words would be translated into computer commands through voice recognition software running on the TMC.

The trans-media controller 14 is a computer with communication capability. The TMC is activated and responsive to communication from the access controller, and preferably responds to telephone keypads. The TMC is programmed to provide the computer access services of the present system, and is accordingly preferably a dedicated computer. However, the TMC may also be a shared portion of another computer, provided sufficient computing and communication capacity is available. The TMC may be located anywhere that is accessible by the telephone system or whatever medium is accessed by the access controller. In particular, the TMC may be conveniently located on the premises or integrated with the computer systems of an Internet service provider, since such establishments already are configured to receive multiple telephone signals and possess high speed Internet connections.

The TMC is configured to receive the unique identifier from the access controller, and from that be prompted to create a virtual personal computing transaction. Upon receiving the unique identifier, the TMC will open the access communication connection to the access controller 12. The access communication connection represents any means or medium by which the TMC communicates with the access controller. Preferably, the ACC will comprise a public or private switched wireless network, such as that used to provide access for cellular telephone communication. The ACC may also be established upon such communications media as the public switched telephone network, WI-Fi network, Bluetooth network, and satellite communication networks.

The TMC will also open the distribution communication connection to establish communication with the target computing output device, i.e. the COD identified by the access controller, The TMC is configured to identify the target computing output device using the unique identifier, and selectively establishes the distribution communication connection with the identified target computing output device. Similar to the ACC, the distribution communication connection is any means or medium by which the TMC communicates with the target computing output device. Preferably the DCC is based on a broadband network. As indicated earlier, a portion of the DCC, such as from a COD located in a retail environment, may comprise a WI-Fi connection.

Upon establishing the ACC and DCC there is a closed connection or circuit between the access controller, trans-media controller, and target computing output device, The TMC will receive instructions from the us r through the access controller via the ACC, and is configured to perform at least one computing function in response to this communication. Upon performing the computing function, the TMC will generate an output of the computing function, and transmit it on the DCC to the target computing output device.

The computing functions may include such common tasks as providing Internet access, displaying a user's personal desktop, displaying a user's personal file, printing a user's personal file, storing a user's personal file in a storage medium, running a user application such as word processing, spreadsheet, or computer game, displaying an image, playing audio from a sound file, and displaying video and playing audio from a streaming video Internet connection.

The computing functions that are general in nature, such as providing access to the Internet or audio and video clips may be provided through the TMC's general access to the Internet or computing functions. The user specific data and applications may be retrieved by the TMC by pre-arrangement or on the user's account. The TMC may contain the user's personal computing data and applications on its own file storage system. Alternatively, the personal computing data and applications of the user may be located on a separate application server (“AS”) 38, as shown in FIG. 1. The AS may be located remote or proximate to the TMC, and is operatively connected to the TMC through an application control interface (“ACI”) 40. The ACI represents any communication media by which the TMC can access and retrieve information from the AS.

The AS may be the user's home computer or the user's company or employer's computer, as long as those computers are accessible through the ACI to the TMC. There may be multiple application servers, for multiple users, and also for multiple functions. For example, an AS may be used to record and keep track of user time for billing purposes. Another AS may contain movies for download to users on request.

The computing output function or information obtained by the TMC is transmitted to the target COD on the DCC. In order to accomplish this the TMC may be required to manage or convert the computer related information, which may for example be in video form, into a form suitable for transmission to the target COD. The TMC thus transforms the signal media, and is the basis for its designation as a “trans-media” controller.

As noted, each computing output device is configured to form the distribution communication connection with the trans-media controller. The COD receives the output from the trans-media controller through its associated NC 18, and actualizes the output for the user. By “actualize” it is meant that it receives the signal, renders it useful for the user, (e.g. displays it on a video screen, or prints it out), so that the computing function request is actively realized by the user.

When the user is finished, the user sends an instruction to the TMC through activation of the access controller. The TMC is configured to terminate the distribution communication connection, and the access communication connection, in response to an instruction from the access controller. The TMC may also terminate the ACC and DCC upon losing a signal for a designated length of time.

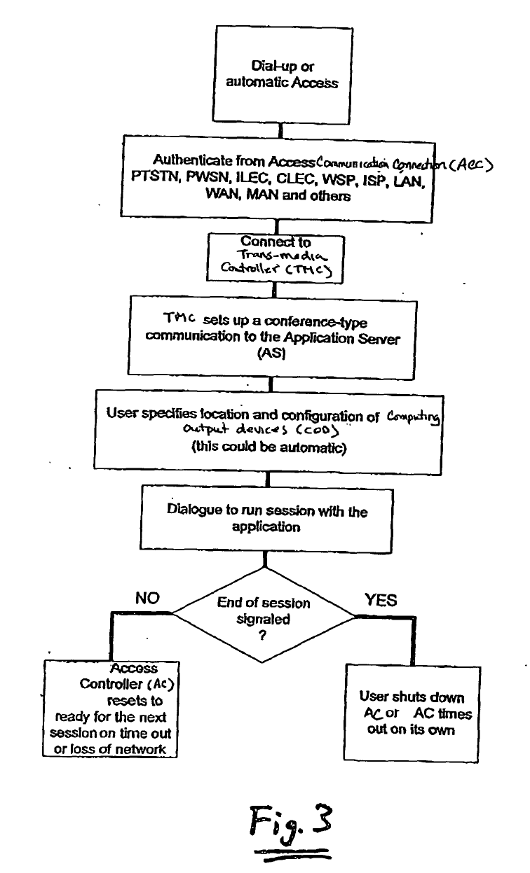

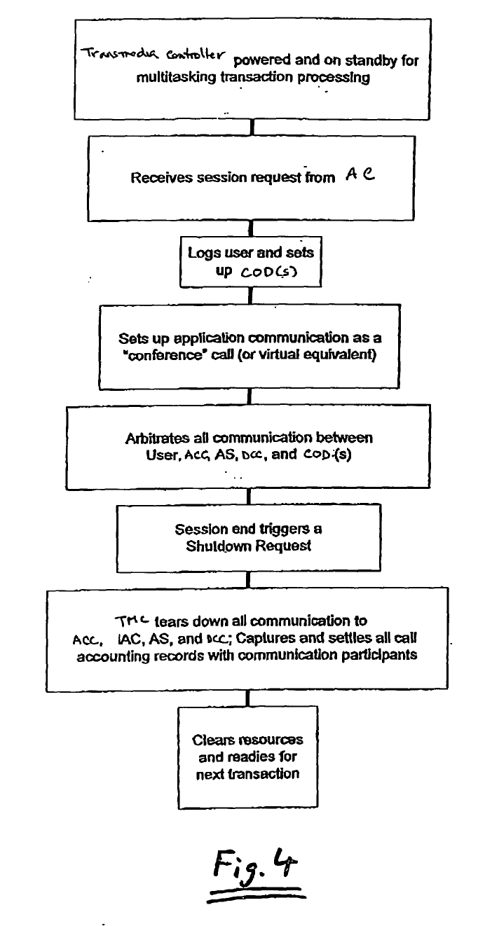

FIG. 3 illustrates the steps executed by the system during a session to facilitate access to data and/or applications. FIG. 4 illustrates the steps taken by the TMC to facilitate communication from an access controller to one or more computing output devices, in response to a session request signal.

The system of the present invention may also include a media processing system to customize the signal sent from the trans-media controller to each of the computing output devices. The media proc ssing system comprises a first marking card 42 installed in the trans-media controller and a second marking card installed in each of the computing output devices. In practice, the first marking card 42 may be implemented as software, and the second marking card may simply be the network connector 18, already used by the system. The media processing system embeds a digital watermark in the signal sent from the trans-media controller to each of the computing output devices. The digital watermark would contain information unique to the transaction, specifically, the identity of the access controller, TMC, and unique identifier of the COD, as well as the date and time. This information could be used for security purposes, and to prevent theft of intellectual property by clearly identifying the user responsible.

It can be appreciated from the above that the system of the present invention enables a user to obtain access to computing function outputs through any one of multiple computing output devices. This is made possible because the output from the TMC can be directed to the target computing output device by virtue of the unique identifier.

Each time a user requests and obtains a computing output function the system of the present invention establishes a connection between an access controller, the TMC, and a particular target COD. This arrangement may also be thought of as being “closed” by the user's interaction with the COD. For example, the user views the screen of a display monitor COD, or picks up a printout from a printer COD. The arrangement whereby the AC, TMC, and COD are set up to form a connection may be considered as a “transaction”, and the TMC functions as a transaction manager, since the TMC forms the connection with the other two devices and opens the ACC and DCC to enable the connection. The TMC also terminates the transaction by closing down the ACC and DCC, and preferably keeps track of billing information and handles other managerial functions. It can be appreciated that in the system of the present invention there may be many transactions constantly being formed and terminated. Each transaction is unique in the sense that it utilizes a particular combination of the elements AC, TMC, and COD, and at a particular date and time. The present syst m may also be viewed as a “virtual personal computing” system, because it re-creates a user's personal computing environment at a remote location or environment.

It can also be appreciated that setting up of the present system is relatively straightforward, since many of the components are readily available. For example, cellular telephones and other common communication devices to be used as access controllers are already in widespread use and would not need to be purchased. Similarly, COD's such as display monitors and print rs are widely used. The network connector would need to be made, but this is a relatively small and inexpensive device since it uses common electronic communication components. COD's that are installed for the system would have NC's built in, so their manufacture would need to be modified slightly. Finally, the TMC as noted could be part of an existing computer, or alternatively be a dedicated computer.

The operation of the present invention may now be understood. The present invention comprises a method of providing computing functions to a user, comprising receiving, through an access communication connection, a unique identifier of a computing output device from a user located proximate to the computing output device. There is then established a distribution communication connection with the computing output device, to enable the transmission of communication signals to the computing output device. Then the TMC provides, through the distribution communication connection, at least A one computing function to the computing output device. Then the COD actualizes the computing function for the user on the computing output device. The TMC terminates the computing function and the communication link upon receiving instructions to terminate from the user, or upon the signal being lost, for whatever reason, for a designated time. This procedure is repeated for each unique identifier of a computing output device received from a user. The method may be enhanced by embedding a digital watermark in the communication signals sent from the trans-media controller to each of the computing output devices.

From the user's point of view, the method of the present invention is also convenient. The invention is a method of obtaining access to computing functions for the user, and comprises the user moving to a location proximate to a computing output device, communicating a unique identifier of the computing output device to the trans-media controller through the access controller, receiving a computing function on the computing output device, and using the access controller to control or direct the operation of the computing function. As noted, the access controller preferably can function like a mouse or a keyboard in a conventional computer program. When finished, the user instructs the trans-media controller to terminate the computing function. The user can move to another location close to another COD and repeat the above steps to gain access to the device. Where the COD is not constructed with this application in mind, for example, if it is a freestanding monitor or printer, the above would be modified by the user attaching an appropriate network A connector 18 to the appropriate input port of the COD prior to transmitting the unique identifier to the TMC. Upon termination, the user would retrieve the network connector for future use.

It has been noted that the COD is preferably a display monitor. This is preferable because it is a common desired computer output function. It is also useful because it provides the most convenient feedback to the user with respect to the application being delivered. If the COD is a different type of device, such as a printer, then the system or TMC may be configured to provide some feedback to the access controller. Alternatively, a Bluetooth transmission from the network connector may fulfill the same function. For example, there could be a list of files on the access controller screen from which the user would select one for printing. In the case of a printer COD, the printer could preferably even be used as a teletype to provide feedback. In cases where there are two COD's side by side, for example a display monitor and a printer, the display monitor could be accessed, and the printer's unique identifier could be entered by the user, upon prompting by the system, when printing is desired. A printer icon would suitably appear on the screen in such situations. The present system might also be used in situations where a keyboard or touchscreen is associated with the COD. It would be preferable however if the keyboard output could be transmitted by Bluetooth back to the access controller, so that the processing by the TMC could be maintained. Where a keyboard is desired, a preferable arrangement would be to attach a keyboard to the access controller. For example, portable keyboards are available that connect with personal digital assistants. Such keyboards for use with personal digital assistants or with cell phones could be readily integrated into the system.

Several examples of operation of the present system may be helpful in illustrating the invention. The system could be used by a user to access the Internet from a retail establishment that has display monitor COD's set up. These units would generally have the network connectors built in, so all the user would have to do is approach the COD and transmit the unique identifier, likely automatically using Bluetooth, to sign on and get online. Billing could be done automatically and could be shared between several providers, such as the providers of the service, the retail establishment, and perhaps an Internet Service Provider. It can be appreciated that this arrangement may be appealing to retail establishments because the display monitors are relatively inexpensive, there may be a new revenue source when the monitors are engaged by the customers. Further, when the monitors are not engaged, they can be programmed to receive downloaded information such as advertising or other information of interest to customers of that particular establishment.

Another scenario involves installing a network connector in a user's home computer or television monitor. The network connector would not interfere with operation of the computer or television monitor in the ordinary course. However its availability might provide the user with the option of ordering an application over the Internet, for example, downloading of a movie by video streaming from a video supplier. The network connector in this case might be installable inside the monitor, since it is a semi-permanent installation.

Such a set-up also offers the possibility of providing theft protection for the monitor, since the NC could shut down signals that arrive in a different environment, which would be the case if the monitor was stolen.

Another example would be a business meeting, for example in a boardroom. A visiting party may wish to obtain files or demonstrate items available on its computer back at the office, but may not have brought the files or its own computer. The boardroom may have an ordinary television set, and a telephone, Under the system of the present invention, the visitor would only need a portable network connector to access his or her office computer. The network connector would simply be connected to the input port of the television. This would allow the otherwise isolated device to be connected to the communication system. The user could then call the TMC on a cell phone or even just use a conventional land based phone in the room. The information or application could then be viewed for the benefit of the meeting participants,

It can be appreciated that the system and method of the present invention provide a number of benefits. In the first place the system facilitates the widespread availability of computing output devices. This is because any ordinary output display monitor, television, printer, or other device located in an office, home, or elsewhere can be recruited simply by connecting an easily attachable network connector. Another factor that contributes to the widespread availability of COD's in the present system is, as noted, that there is a commercial incentive for private retail establishments to install COD units.

In addition to widespread availability of COD's, the system enables relatively easy access. All that is needed is a telephone and in some cases a network connector. It may be noted that the telephone connection from the access controller to the TMC preferably provides for 2-way communication, and is a relatively easy connection to establish because of the universality of the telephone system, and the increasing popularity of cellular telephones in particular. It may also be noted that the connection from the TMC to the COD need only be one-way, and this simplifies the system and greatly enhances its flexibility. For example, the distribution communication channel from the TMC to the COD may be supplied by a direct satellite link. The satellite signal may be quite weak, but the network connector should be able to detect it. If the network connector had to transmit back to the satellite, its requirements would be much more onerous. In this way, the system facilitates communication as it can be activated with a simple phone call, and the transaction can be closed using only a simple one-way communication to the COD.

It will be appreciated by those skilled in the art that the foregoing description was in respect of preferred embodiments and that various alterations and modifications are possible within the broad scope of the appended claims without departing from the spirit of the invention. For example, while reference is made to using the keyboard or joystick on a cell phone as a mouse, for example, other ways of using a cell phone such as a pointer or light emitter attached to the phone itself might also be used. Various other modifications will be apparent to those skilled in the art but are not described in any further detail herein.

1. A system for providing computing functions to a user, said system comprising:
(a) an access controller, a trans-media controller, and at least one computing output device;
(b) the access controller being configured to:
(i) be controlled by said user so as to permit the user to selectively establish an access communication connection with the trans-media controller; and to
(ii) communicate with said trans-media controller through said access communication connection;
(c) the trans-media controller being configured to:
(i) perform at least one computing function in response to a communication from the access controller via the access communication connection;
(ii) generate an output of said computing function;
(iii) selectively establish a distribution communication connection with a target computing output device; and to
(iv) transmit said output to the target computing output device; and
(d) each of the computing output devices being configured to:
(i) form a distribution communication connection with the trans-media controller;
(ii) receive the output from the trans-media controller via the distribution communication connection; and to
(iii) actualize the output for the user.

2. A system according to claim 1, wherein each computing output device has a unique identifier, and wherein the access controller is configured to transmit a unique identifier of the target computing output device to said trans-media controller through said access communication connection, and wherein the trans-media controller is configured to identify said target computing output device using said unique identifier; whereby a user can obtain access to computing function output through any one of multiple computing output devices, and the output can be directed to the target computing output device by virtue of the unique identifier.

3. A system according to claim 2, wherein each of the computing output devices is configured to transmit its unique identifier to the user.

4. A system according to claim 3, wherein the identifier is transmitted electronically to the access controller, and wherein the access controller is configured to receive the identifier and transmit the identifier to the trans-media controller.

5. A system according to claim 4, wherein the identifier is transmitted via the Bluetooth communication protocol.

6. A system according to claim 3, wherein the identifier is transmitted visually to the user by the display of the identifier on the computing output device, and wherein the access controller is configured to receive a manual input of the identifier and transmit the identifier to the trans-media controller, whereby the identifier can be manually inputted by the user into the access controller and transmitted by the access controller.

7. A system according to claim 1, wherein the trans-media controller is configured to terminate the distribution communication connection in response to an instruction from the access controller.

8. A system according to claim 1, wherein the trans-media controller is configured to terminate the access communication connection in response to an instruction from the access controller.

9. A system according to claim 1, wherein each of said computing output devices includes a network connector, to form said distribution communication connection with the trans-media controller

10. A system according to claim 9, wherein said network connector is sized and shaped to be operatively connected by said user to said computing output device.

11. A system according to claim 9, wherein said network connector is sized and shaped to be installed as an integral component of said computing output device.

12. A system according to claim 1, wherein said access communication connection includes at least one communication medium selected from the group of: public switched telephone network, public switched wireless network, private switched wireless network, Wi-Fi network, Bluetooth network, and a satellite communication network.

13. A system according to claim 12, wherein said access communication connection includes a private switched wireless network for cellular telephone access.

14. A system according to claim 1, wherein said distribution communication connection includes a high speed Internet connection.

15. A system according to claim 14, wherein said computing output devices form said distribution communication connection through a Wi-Fi system connection.

16. A system according to claim 1, wherein said computing functions include at least one function selected from the group of: providing Internet access, displaying a user's personal desktop, displaying a user's personal file, printing a user's personal file, storing a user's personal file in a storage medium, displaying an image, playing audio from a sound file, and displaying video and playing audio from a streaming video Internet connection.

17. A system according to claim 1, wherein said computing output device is selected from the group of: a display monitor, a printer, an audio speaker set, and a computer memory storage device.

18. A system according to claim 1, wherein said access controller is configured to provide to said trans-media controller instructions relating to the position of a pointer or cursor, and instructions providing keyboard input.

19. A system according to claim 18, wherein said access controller includes at least input feature, and said access controller is configured so that activating said input feature directs the trans-media controller to change the position of a pointer or cursor in a predetermined direction and by a predetermined distance.

20. A system according to claim 1, wherein said access controller accesses said access communication connection through a wireless connection.

21. A system according to claim 20, wherein said access controller is selected from the group of: a cellular telephone, a wireless telephone, a pager, a personal data assistant, and a mobile computer.

22. A system according to claim 1, wherein said access controller accesses said access communication connection through a wired connection.

23. A system according to claim 22, wherein said access controller is selected from the group of: a wired telephone, and a wired computer.

24. A system according to claim 1, wherein said trans-media controller contains personal computing data and applications of said user.

25. A system according to claim 1, further including an application server, said application server containing personal computing data, and applications of said user and being operatively connected to said trans-media controller through an application control interface.

26. A system according to claim 25, wherein said application server is located remote from said trans-media controller.

27. A system according to claim 1, further including a media marking system to customize a signal sent from the trans-media controller to each of said computing output devices.

28. A system according to claim 27, wherein said media marking system comprises a first marking card installed in said trans-media controller and a second marking card installed in each of said computing output devices.

29. A system according to claim 27, wherein said media marking system embeds a digital watermark in said signal sent from the trans-media controller to each of the computing output devices.

30. A network connector for a computing output device, comprising:
(a) a unique identifier;
(b) a communication receiver adapted to receive a communication signal;
(c) a cryptograph circuit operatively connected to said communication receiver, to unscramble the communication signal;
(d) a decompression circuit, operatively connected to said cryptograph circuit, to decompress the communication signal; and
(e) a media output circuit, operatively connected to said decompression circuit, to provide and adapt the communication signal for output to said computing output device.

31. The network connector according to claim 30, wherein said communication receiver is configured to receive communication signals according to the Wi-Fi communication standard.

32. The network connector according to claim 30, further including a communication transmitter to transmit said unique identifier to a proximate communication device.

33. The network connector according to claim 32, wherein said communication transmitter transmits according to the Bluetooth communication standard.

34. The network connector according to claim 30, wherein the network connector is sized and shaped to be portable by a user, and wherein said network connector further includes an attachment mechanism to physically connect said network connector to an input port on said computing output device.

35. The network connector according to claim 30, wherein said network connector is sized and shaped to be installed integral to said computing output device.

36. A method of providing computing functions to a user, said method comprising:
(a) receiving through an access communication connection a unique identifier of a computing output device from a user located proximate to said computing output device;
(b) establishing a distribution communication connection with said computing output device, to enable the transmission of communication signals to said computing output device;
(c) providing, through said distribution communication connection, at least one computing function to said computing output device;
(d) actualizing said computing function for said user on said computing output device;
(e) terminating said computing function and said communication link upon receiving instructions to terminate from said user;
(f) repeating said steps (a) to (e) upon receiving a further unique identifier of a computing output device from a user.

37. A method of providing computing functions to a user according to claim 36, said method further including the step of embedding a digital watermark in said communication signals sent from the trans-media controller to each of said computing output devices.

38. A method of obtaining access to computing functions for a user, said method comprising:
(a) moving to a location proximate to a computing output device;
(b) communicating a unique identifier of said computing output device to said trans-media controller through said access controller;
(c) receiving a computing function on said computing output device;
(d) using said access controller to direct the operation of said computing function;
(e) instructing said trans-media controller to terminate said computing function; and
(f) repeating said steps (a) to (e) upon moving to a location proximate to another computing output device.

39. A method of obtaining access to computing functions for a user according to claim 38, said method further including the steps of:
(a) attaching to said computing output device, prior to step (b) above, a network connector, said network connector being sized and shaped to operatively connect to said computing output device; and
(b) removing said network connector from said computing output device after step (e) above.
